(19) United States
(12) Patent Application Publication
(10) Pub. No.: US 2026/0021681 A1
(43) Pub. Date: Jan. 22, 2026

(54) TOW HOOK ASSEMBLY

(71) Applicant: SCOUT MOTORS INC., Tysons, VA (US)

(72) Inventors: Kris Warmann, Tysons, VA (US); Djamal Midoun, Tysons, VA (US); Randy Frank, Tysons, VA (US); Joerg Wendekamm, Tysons, VA (US); David Lepley, Tysons, VA (US)

(21) Appl. No.: 18/774,756

(22) Filed: Jul. 16, 2024

(51) Int. Cl. B60D 1/04; B60D 1/24; B60D 1/48

(52) U.S. Cl. CPC B60D 1/04; B60D 1/485; B60D 1/243

(57) ABSTRACT

Provided herein is a tow hook assembly, and more specifically, a tow hook assembly that is employed to improve passenger safety of a vehicle particularly in an offset vehicle impact. A tow hook assembly may include a mounting plate configured to be attached to a structural member of a vehicle at a front end of the vehicle, the mounting plate comprising a first portion and a second portion; and a tow hook extending from the first portion of the mounting plate in a first direction away from the vehicle, where the second portion of the mounting plate extends laterally outboard from the first portion in a second direction that is perpendicular to the first direction. The tow hook, during a small overlap impact with an object, provides for a lateral push away from the object.

### BACKGROUND

Occupant protection in a vehicle is of utmost importance. Safety requirements of vehicle have increased and improved over time, and manufacturers strive to exceed these requirements in the interest of occupant safety. Various methods of testing the safety of vehicles have been developed in an effort to mimic the various types of accidents in which vehicles can be involved. These methods of testing are implemented by both public and private entities, with safety ratings awarded to vehicles that perform above established standards.

While frontal crash tests were long thought the benchmarks for safety, such crash tests did not reflect many real-world accidents. Partial front-end collisions are believed to be more common and vehicles that perform well on a full frontal crash test may not perform well on partial front-end crash tests. Thus, additional crash tests have been developed to better measure a vehicle's occupant protection in various types of crashes.

### BRIEF SUMMARY

An apparatus is therefore provided for a tow hook assembly, and more specifically, a tow hook assembly that is employed to improve passenger safety of a vehicle particularly in an offset vehicle impact. Some embodiments provided herein are directed to a tow hook assembly including: a mounting plate configured to be attached to a structural member of a vehicle at a front end of the vehicle, the mounting plate comprising a first portion and a second portion; and a tow hook extending from the first portion of the mounting plate in a first direction away from the vehicle, where the second portion of the mounting plate extends laterally outboard from the first portion in a second direction that is perpendicular to the first direction, configured such that in an impact with an object contacting the vehicle in a direction parallel to the first direction only from the tow hook assembly toward the second direction, the second portion of the mounting plate is pushed rearward causing a rotation of the tow hook assembly and, in turn, a lateral push to the vehicle in a third direction, opposite the second direction.

In response to the rotation of the tow hook assembly in some embodiments, the tow hook extending from the first portion from the mounting plate engages the object and pushes the vehicle and the object away from one another. According to some embodiments the structural member includes a front cross member of the vehicle, where the mounting plate is attached to the front cross member at a position where the tow hook aligns with a longitudinal rail of the vehicle extending perpendicular to the front cross member. The tow hook assembly of some embodiments further includes an extension member, where the extension member is attached at a first end to the mounting plate configured to be received within the longitudinal rail.

According to certain embodiments, the extension member defines a tab proximate a second end of the extension member, opposite the first end of the extension member. The tab of some embodiments is configured to engage a catch attached within the longitudinal rail in response to the impact with the object contacting the vehicle. The extension member of some embodiments is configured to rotate toward the second direction about a location of attachment of the catch to the longitudinal rail in response to the impact. According to some embodiments, the location of attachment of the catch corresponds to a position of a second cross member attached to the longitudinal rail.

The tow hook assembly of some embodiments further includes a wedge member attached to the front cross member opposite the second portion of the mounting plate and extending in a fourth direction, opposite the first direction. The wedge member of some embodiments is configured to impart a bend in the longitudinal rail toward the second direction in response to the impact with the object. The tow hook of certain embodiments is positioned on the vehicle twenty five percent of a width of the vehicle from a centerline extending through a length of the vehicle.

Some embodiments provided herein are directed to a tow hook assembly including: a mounting plate configured to be attached to a front cross member of a vehicle at a front end of the vehicle, the mounting plate including a first portion and a second portion; and a tow hook extending from the first portion of the mounting plate in a first direction away from the vehicle, where the second portion of the mounting plate extends laterally outboard from the first portion in a second direction that is perpendicular to the first direction, where the first portion of the mounting plate is aligned on the front cross member with a longitudinal rail of the vehicle.

The tow hook assembly of some embodiments further includes an extension member, where the extension member is attached at a first end to the mounting plate configured to be received within the longitudinal rail. The extension member of some embodiments further includes a tab, where the tab is configured to engage a catch within the longitudinal rail in response to a small overlap frontal impact of an object with the tow hook assembly. According to some embodiments the catch is aligned within the longitudinal rail with another cross member of the vehicle.

Some embodiments provided herein are directed to a vehicle including: a vehicle structure comprising a front cross member and a longitudinal rail attached to the front cross member; a tow hook assembly including: a mounting plate configured to be attached to the front cross member of the vehicle, the mounting plate comprising a first portion and a second portion; and a tow hook extending from the first portion of the mounting plate in a first direction away from the front cross member, where the second portion of the mounting plate extends laterally outboard from the first portion in a second direction that is perpendicular to the first direction, wherein the first portion of the mounting plate is aligned on the front cross member with the longitudinal rail of the vehicle.

According to some embodiments the tow hook further includes an extension member, where the extension member is attached at a first end to the mounting plate and extends into the longitudinal rail. The extension member of some embodiments further includes a tab, and the longitudinal rail further includes a catch within the longitudinal rail, where the tab is configured to engage the catch within the longitudinal rail in response to a small overlap frontal impact of an object with the tow hook assembly. According to some embodiments the vehicle structure further includes another cross member attached to the longitudinal rail, where the catch is aligned within the longitudinal rail with the another cross member. The vehicle of some embodiments further includes a wedge member attached to the front cross member opposite the second portion of the mounting plate and extending in a third direction, opposite the first direction, wherein the mounting plate is disposed outboard of the longitudinal rail relative to the vehicle.

### BRIEF DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 illustrates a diagram of a small overlap test, where a vehicle impacts a barrier at a predetermined speed according to an example embodiment of the present disclosure;

FIG. 2 illustrates generalized structural elements of a vehicle according to an example embodiment of the present disclosure;

FIG. 3 illustrates a vehicle structure with the lateral pushing mechanism according to an example embodiment of the present disclosure;

FIG. 4 illustrates the physics involved in a small overlap impact test for the vehicle employing a tow hook and mounting plate secured to the front cross member according to an example embodiment of the present disclosure;

FIG. 5 illustrates vehicle impact with a barrier and movement of the vehicle away from the barrier according to an example embodiment of the present disclosure;

FIG. 6A illustrates a top view of a tow hook and mounting plate according to an example embodiment of the present disclosure;

FIG. 6B illustrates a side view of the tow hook of FIG. 6A according to an example embodiment of the present disclosure;

FIG. 7 illustrates a mechanism to facilitate a lateral push away from a barrier during an impact with the barrier according to an example embodiment of the present disclosure;

FIG. 8 illustrates the vehicle structure shortly after a small overlap impact with a barrier according to an example embodiment of the present disclosure;

FIG. 9 illustrates another mechanism to facilitate a lateral push away from a barrier during an impact with the barrier according to an example embodiment of the present disclosure; and

FIG. 10 illustrates the vehicle structure shortly after a small overlap impact with a barrier according to an example embodiment of the present disclosure.

### DETAILED DESCRIPTION

Some embodiments of the present disclosure will now be described more fully hereinafter with reference to the accompanying drawings, in which some, but not all, embodiments are shown. Indeed, various embodiments of the present disclosure may be embodied in many different forms and should not be construed as limited to the embodiments set forth herein; rather, these embodiments are provided so that this disclosure will satisfy applicable legal requirements. Like reference numerals refer to like elements throughout.

Occupant protection in various types of crashes is of utmost importance. Different types of collisions are mitigated in different ways by vehicle structures. One crash test in which it is difficult to mitigate the effects is the small overlap rigid barrier crash test introduced by the Insurance Institute for Highway Safety (IIHS). In the small overlap test, a vehicle impacts a rigid barrier at 40 mph, with 25% of the vehicle's width overlapping the barrier. The barrier includes a radius transition from the front of the barrier to a side of the barrier. This impact is challenging to mitigate as substantially the full force of a 40 mph impact needs to be mitigated by only 25% of the frontal structure of a vehicle.

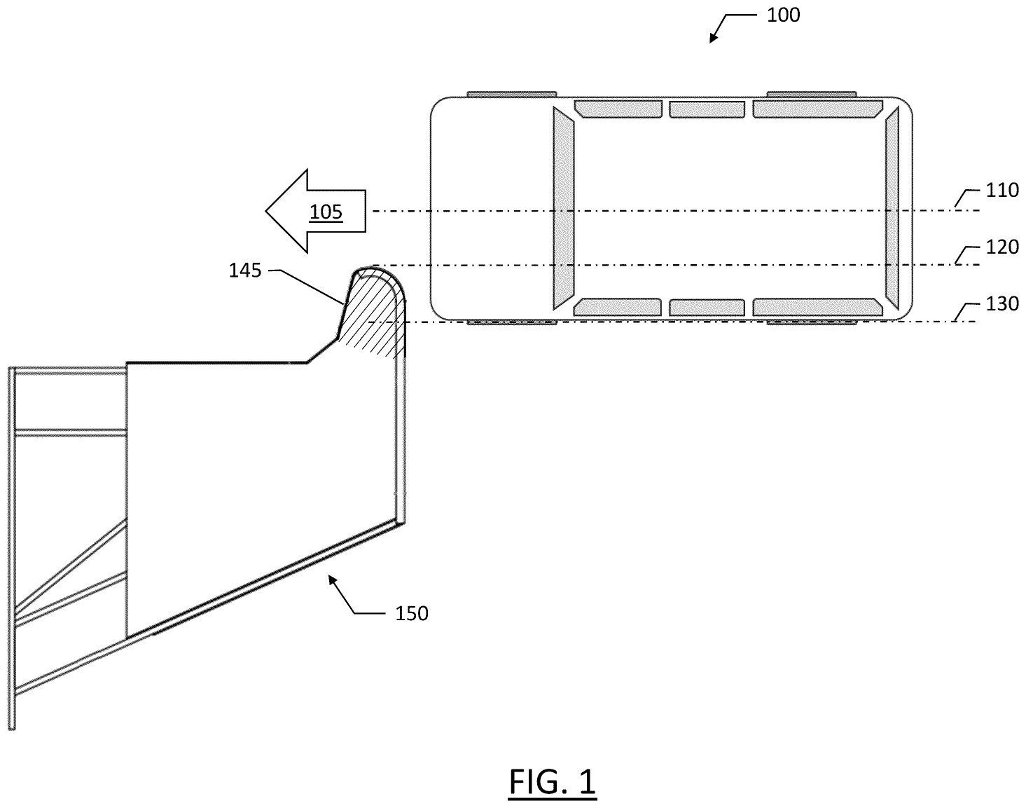

FIG. 1 illustrates a diagram of the small overlap test, where a vehicle 100 traveling in the direction of arrow 105 impacts a barrier 150 at a predetermined speed. Rather than the entire front of the vehicle 100 impacting the barrier 150 in the small overlap test, only 25% of the width is impacted. This is illustrated based on the centerline 110 of the vehicle 100, a line 120 shown at 25% of the width of the vehicle, or halfway between the centerline of the vehicle, and a line 130 at a side of the vehicle's width. The illustrated barrier 150 is a general illustration of the barrier used in the standardized IIHS small overlap test. However, in later figures only the shaded portion 145 of the barrier 150 will be shown to detail the area of impact of the vehicle in the test. Further, while the impact illustrated and described herein is generally with respect to the small overlap test, such a test is only an illustration of the functionality of the embodiments described herein which improves performance in real world impacts that the small overlap test is designed to mimic in a controlled environment.

Absorbing the impact of the small overlap test with only 25% of the vehicle's frontal structure is challenging. Occupant protection in small overlap rigid barrier impacts can be enhanced through structure designs that provide a lateral “push” to the striking vehicle that helps the vehicle deflect off of the barrier and move past the rigid barrier rather than engaging with the barrier. Without this lateral push, additional structure may be necessary to reinforce the structure of the vehicle, particularly in the outboard 25% of the width to absorb the concentrated crash energy. The additional structure would add to both the cost and the weight of the vehicle, which also degrades efficiency. Some embodiments provided herein employ a tow hook assembly to provide this lateral push to improve occupant safety in the small overlap test.

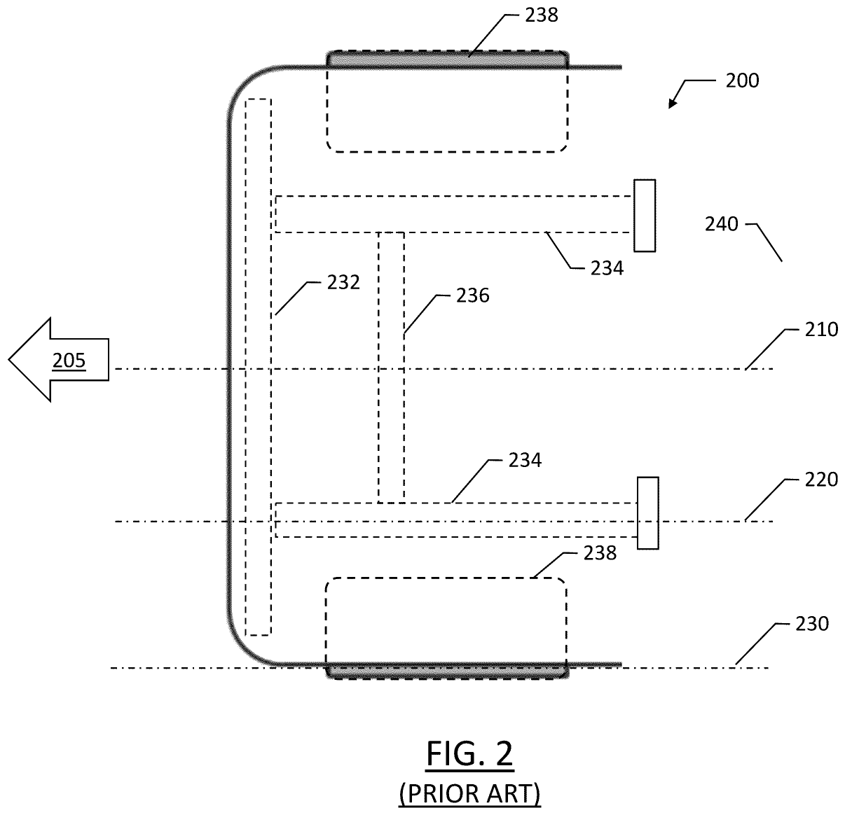

FIG. 2 illustrates generalized structural elements of a vehicle, some of which may or may not be present in a vehicle. Body-on-frame vehicles generally include a frame, such as a ladder box frame and a body that sits atop the frame. Unibody vehicles incorporate a body of the vehicle into the vehicle structure, and do not have a full-length frame. However, certain features of a frame are often still found within a unibody vehicle, such as front frame and/or rear frame members that resemble portions of a conventional ladder frame. For purposes of the present disclosure, the general components of a vehicle's structure and function thereof are described generally and as the disclosure focuses on a frontal end of a vehicle, the components described with respect to the structure can apply to any type of vehicle structural architecture.

FIG. 2 illustrates a front end of a vehicle 200 with the front of the vehicle pointed toward the direction of travel shown by arrow 205 with vehicle centerline 210. Also shown are vehicle width line 230 and the line 220 midway between the centerline 210 and the width line 230 reflecting 25% of the width of the vehicle 200. The front wheels 238 are illustrated, though the steering and suspension structure between the vehicle structure and the wheels is omitted. The general frontal structure components described herein include a front cross member 232, which may be referred to in some embodiments as a bumper bar as this front cross member 232 either forms part of or is connected to a front bumper of a vehicle. Also shown are longitudinal rails 234. The longitudinal rails 234 form a substantial component of the frontal structure configured to absorb crash energy. The longitudinal rails 234 of some embodiments include therebetween additional cross members such as cross member 236. The front cross member 232, longitudinal rails 234, and cross member 236 may be formed in a variety of ways from a variety of different materials. For example, longitudinal rails may be C-channel members or have an I-beam configuration having top and bottom plates joined by a vertical plate. Optionally, the longitudinal rails may be “fully boxed” or channels that have a square or rectangular cross section formed of metal having a channel defined there through. The cross members may be similarly configured, or may be formed using different techniques, such as cast members, stamped sheet metal, or the like.

The structural members illustrated in FIG. 2 provide at least a portion of a crush energy absorbing structure for a frontal impact. At least some embodiments provided herein include a lateral pushing structure configured to improve small overlap crash performance that does not adversely impact a full overlap rigid barrier impact and does not increase the loads required to crush energy absorbing portions of the vehicle longitudinal rails.

The system described herein to provide a lateral pushing structure for the small overlap crash test is adapted to be suitable for use with any type of vehicle. Vehicles that are equipped for off-road use may be designed to accommodate large tires and short front overhangs that enable steep approach angles such that there is minimal packaging area in front of the wheel area for a lateral pushing structure. Vehicles designed to be off-road capable also benefit from the inclusion of a tow or recovery hook attached to the vehicle. At least some embodiments described herein integrate a lateral pushing structure for small overlap rigid barrier impacts with a front tow hook to create a lateral pushing structure that requires minimal packaging space and can be accommodated forward of the front tires in vehicles that are designed to be off-road capable. Further, some embodiments do not have a negative impact on full overlap impact crash worthiness.

At least some embodiments described herein provide for lateral pushing during a partial overlap impact with a barrier without requiring significant structure outboard of the longitudinal rails and aft of the front cross member such that off-road capabilities can be maintained through the use of a short front overhang (distance from the front of the front tire to the end of the front bumper) and the ability to use large off-road tires.

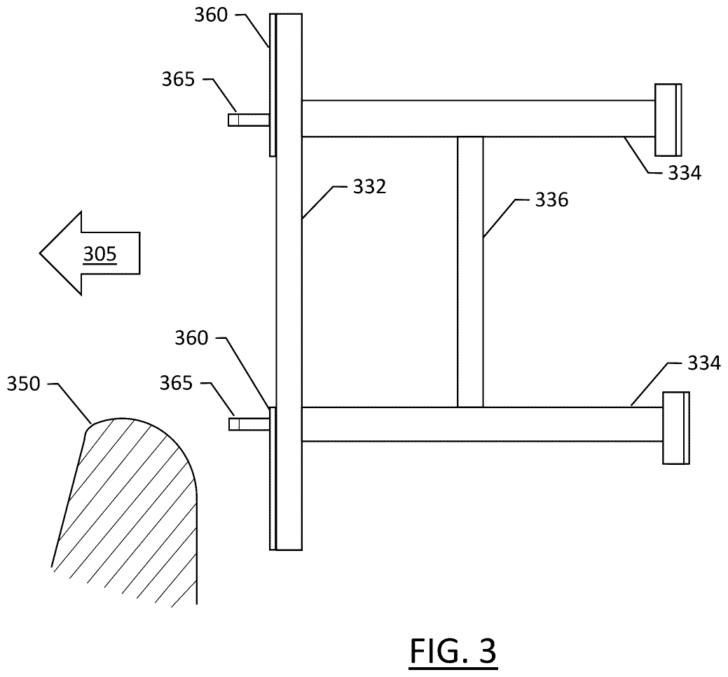

Some embodiments described herein include a tow hook aligned and attached to the front of a vehicle. Some embodiments include a tow hook that is aligned with a longitudinal rail of the vehicle as described further below. A mounting plate of the tow hook extends outboard from the tow hook and can in some embodiments extend up to or past the furthest outboard lateral position of the front cross member. FIG. 3 illustrates a vehicle structure with the lateral pushing mechanism according to an example embodiment. FIG. 3 depicts a barrier 350 at a position of a small overlap front impact test barrier and a direction of travel shown by arrow 305. As shown, the structure of a vehicle includes longitudinal rails 334 attached to a front cross member 332 and connected by cross member 336. Attached, at least indirectly, to the front cross member 332 proximate each end is a tow hook 365 securely attached to mounting plate 360. The tow hook 365 and mounting plate 360 can be mounted directly to the front cross member 332; however, in some cases the front cross member 332 may be mounted behind an ornamental or cosmetic bumper cover, such that the mounting plate 360 and tow hook 365 may be mounted to the front cross member 332 through such a cover. The mounting between the tow hook 365, mounting plate 360, and the front cross member 332 is substantially rigid as the mounting provides a path for force to be transmitted during an impact.

The tow hook(s) described herein generally reference a protruding element on a vehicle that is used for connection to the vehicle of, for example a tow cable, winch, or other connection used to pull the vehicle, or for the vehicle to pull an object tethered to the tow hook. The specific shape of the tow hook is not defined by the term “hook” and should not be interpreted as a shape having a sharp bend at one end and an open at one end. Conversely the tow hooks described herein can be conventional “hook” shape, squared, circular hoops, U-shaped, and open or closed loops. Thus, a tow hook describes the general function and not the shape of the tow hooks described herein.

The tow hook 365 and mounting plate 360 are formed of a material having high strength and rigidity to perform as described herein during an impact. While the mounting plate can be a solid plate of material, such as high carbon steel, the mounting plate can optionally be formed of a ribbed plate, lattice structure, or other known structure that can provide the necessary rigidity under substantial dynamic loads of a vehicle impact. Similarly, the tow hook can be of a rigid material that is not only sufficient to perform as a tow hook of the vehicle, but also to provide the lateral pushing motion described herein. These structural elements are thus described as strictly rigid elements; however, it is understood that depending upon the material type and geometry of each piece, along with a force of impact, there may be some degree of flexing of the tow hook and mounting plate during an impact. The goal of the tow hook and mounting plate of at least some embodiments described herein is to provide some degree of lateral movement by way of a lateral push of the vehicle to help improve safety of the passenger compartment of the vehicle. Thus, the tow hook, mounting plate, and other structural elements present in some embodiments are understood to be of a material and geometry sufficient to accomplish this task, while not deviating from the present disclosure.

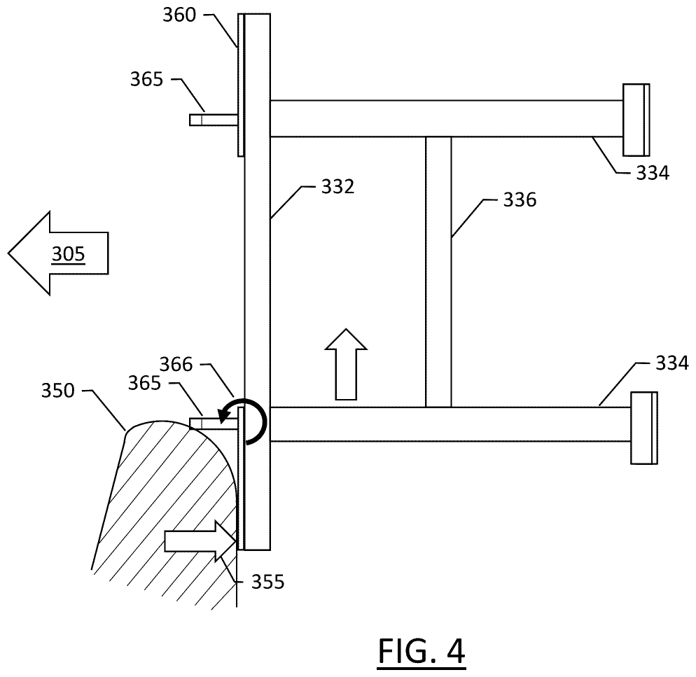

The tow hook of the illustrated embodiment of FIG. 4 includes a tow hook 365 aligned and attached to the front cross member 332 and aligned with a longitudinal rail 334 of the vehicle. The mounting plate 360 extends laterally outboard from the tow hook 365 and in the illustrated embodiment extend the outboard length of the front cross member 332. However, the lateral extension of the mounting plate 360 can be longer or shorter depending on a number of variables. In a small overlap impact, the barrier is aligned substantially outboard of the vehicle longitudinal rails. When the vehicle impacts the barrier, the lateral extension of mounting plate 360 is pushed rearward by the force of impact shown at arrow 365, causing the tow hook 365 to rotate toward the barrier as shown by arrow 366 and provide a lateral push to the vehicle, away from the barrier 350.

The effectiveness of the lateral push is influenced by the lateral stiffness of the vehicle frame including the lateral stiffness of the longitudinal members 334 and a length of the tow hook 365 in front of the vehicle. This lateral push also relies upon the tow hook 365 being rigidly attached to the mounting plate 360 and not substantially bending away from the lateral extension of the mounting plate 360 during an impact.

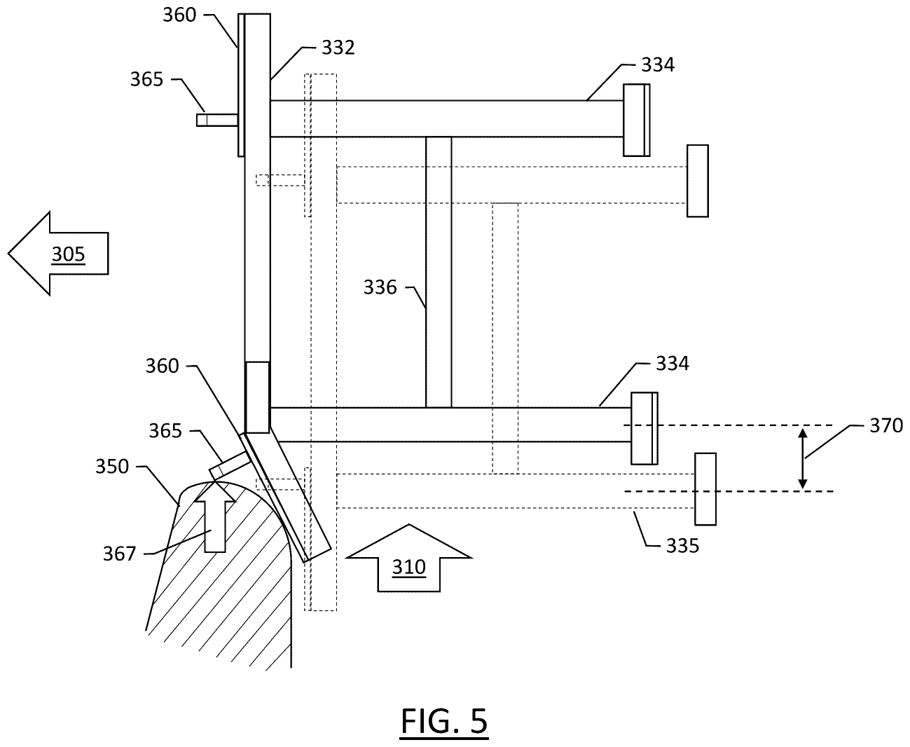

FIG. 5 illustrates the physics involved in a small overlap impact test for the vehicle employing certain embodiments of the tow hook 365 and mounting plate 360 secured to the front cross member 332. The dashed line representation of the vehicle structure reflects the original lateral position 335 of the vehicle structure, while the solid line representation of the vehicle structure reflects the immediately post-impact position. As shown, the mounting plate 360 bends with the front cross member 332, causing rotation of the tow hook 365, where the tow hook pushes against the barrier at 367, helping drive the vehicle structure laterally away from the barrier in a direction shown by arrow 310. This causes lateral displacement shown by arrow 370 from the original lateral position 335.

The lateral displacement during the small overlap impact test can significantly improve vehicle performance during the test, by reducing the proportion of the vehicle impacted, and reducing an amount of the vehicle that is pressed toward the passenger compartment. The tow hook 365 and mounting plate 360 described above helps mitigate a direct impact and endeavors to turn the direct impact into a glancing blow to improve passenger safety without requiring significant additions to the vehicle structure and weight.

During a full-frontal impact or partial front impact when an object is impacted at least partially between the longitudinal rails 334 the lateral extension of the mounting plate 360 is loaded by a flat face without creating any rotation of the tow hook 365, and certain embodiments described herein do not adversely influence the crush characteristics of the vehicle structure, such as the longitudinal rails, during a frontal impact.

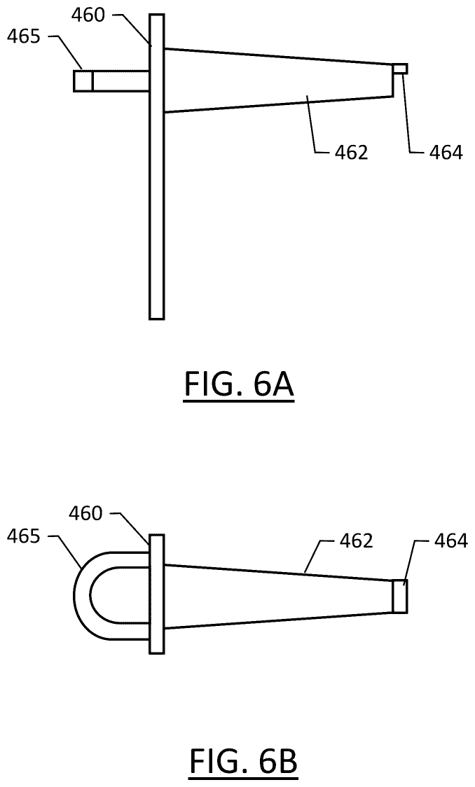

At least some embodiments described herein can include an extension to the tow hook that adds a structural component to help urge the tow hook and mounting plate in the desired direction during a small overlap impact. FIGS. 6A-8 illustrate such an embodiment. FIG. 6A illustrates a top view of the tow hook 465 and mounting plate 460, separate from the vehicle structure. As shown, the embodiment of FIG. 6A further includes extension 462 which in the illustrated embodiment is a tapered element. This extension 462 is rigidly secured to the mounting plate 460 and tow hook 465 and includes a tab 464 which is a solid structural element of the extension. FIG. 6B illustrates a side view of the tow hook 465, mounting plate 460, extension 462, and tab 464.

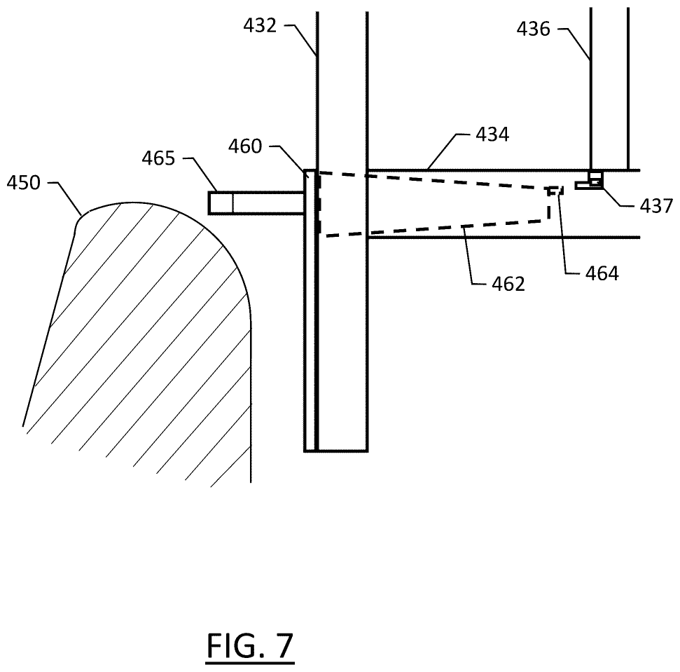

FIG. 7 illustrates the tow hook 465 and mounting plate 460 as secured to a front cross member 432 of a vehicle. The extension 462 of the illustrated embodiment is received within the longitudinal rail 434, which may include a fully boxed frame member. Within the longitudinal rail 434 is a catch 437 rigidly attached within the longitudinal rail. In some embodiments, the catch 437 is positioned within the longitudinal rail 434 proximate a location of another cross member 436 as depicted in the illustrated embodiment. The extension 462 and the tab 464 can aid in developing a lateral push of the vehicle during a small overlap impact with barrier 450.

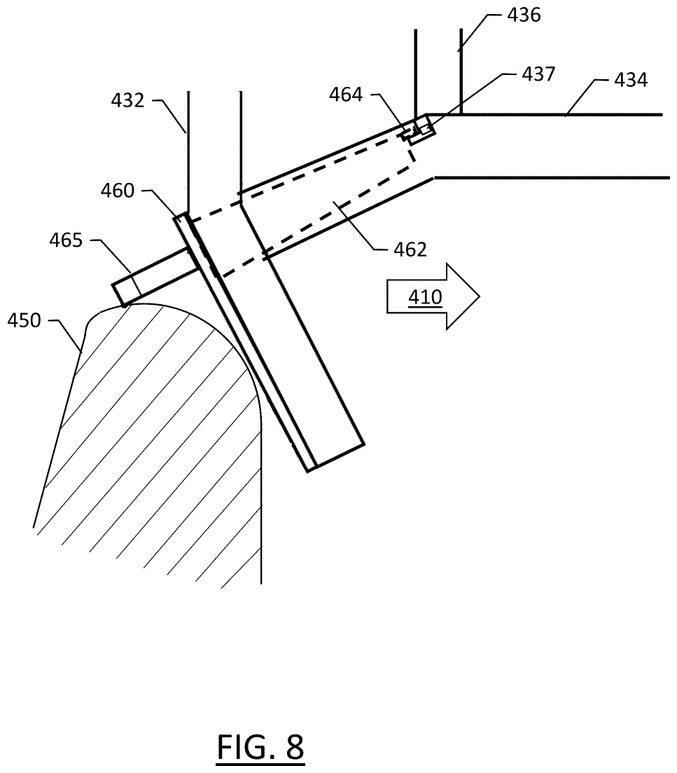

FIG. 8 illustrates the vehicle structure shortly after the small overlap impact with the barrier 450. As shown, the mounting plate 460 and tow hook 465 impact the barrier and cause bending of the front cross member 432. This bend is facilitated in the illustrated embodiment by extension 462. During the impact, the tow hook 465, mounting plate 460, and extension 462 are driven back in the general direction of arrow 410 with respect to the vehicle structure. The tow hook 465 and mounting plate 460 initiate the rotation of the portion of the front cross member 432 outboard of the longitudinal rail 434. During this movement, the tab 464 is driven back to engage the catch 437. Upon the tab 464 engaging the catch 437, the extension creates a more rigid section of the longitudinal rail 434 between the cross member 436 and the front cross member 432. This more rigid section of longitudinal rail serves as a lever, bending and rotating about a point near the catch 464. This additional lever helps propel the lateral push of the vehicle structure past the barrier 450, rendering the impact a more glancing blow than a direct impact. During a frontal impact, the extension 464 would not engage the catch 437, such that the structural rigidity of the longitudinal rail 434 between the front cross member 432 and the catch 437 is unchanged, and the extension simply slides within the longitudinal rail as the front cross member is driven aft in the vehicle.

The front cross member 432 is shown in FIG. 8 to shift left of the vehicle, toward the barrier 450 during the impact. This can result from the entire front cross member 432 shifting left as the front cross member is pulled by the forces acting on the tow hook 465 and mounting plate 460. Optionally, the front cross member 432 can include a feature that permits the front cross member to shift laterally on one side of the vehicle separately from the other. Such a mechanism can include, for example, a joining feature of the front cross member between the longitudinal rails. This could include a slide-fit joint that is structurally sound during a frontal impact but can be pulled apart laterally in an impact such as the small overlap impact.

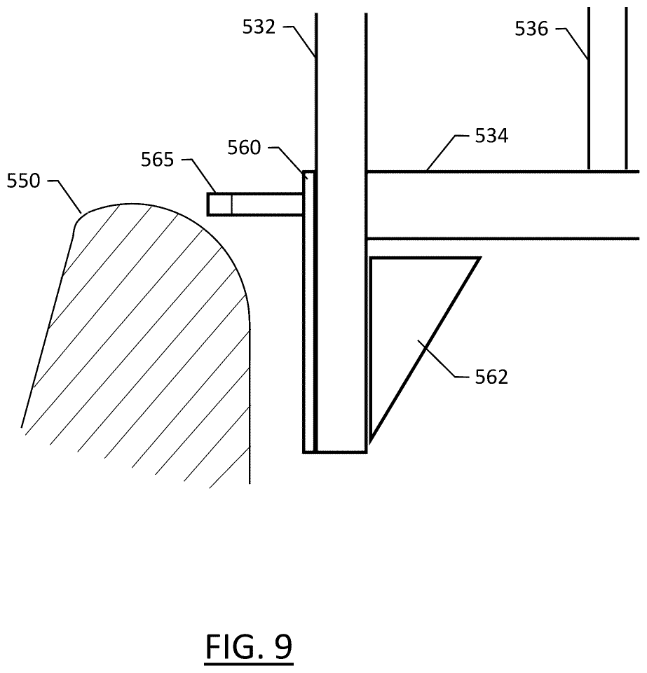

At least some embodiments described herein include another mechanism to function as a lever during a small overlap frontal impact. FIG. 9 illustrates the tow hook 565 and mounting plate 560 secured to the front cross member 532. Also shown is a wedge 562 secured to an aft side of the front cross member outboard of the longitudinal rail 534. As will be appreciated based on the description and illustration of the functionality of the wedge 562, shapes other than the triangular shape shown in the figures can be employed to achieve a similar effect. The shape of the wedge 562 illustrated reduces the intrusion into the area where a wheel and tire may be present, which can allow for a larger wheel and/or tire to occupy the wheel well.

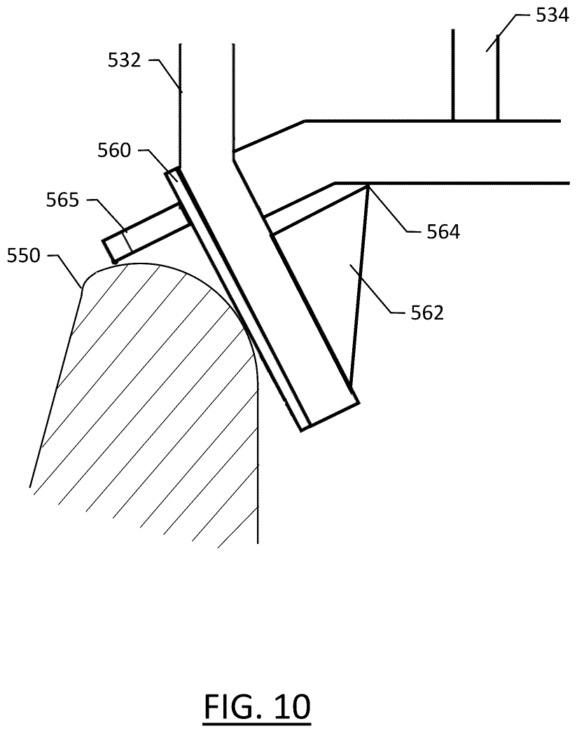

FIG. 10 illustrates the vehicle structure shortly after the small overlap impact with the barrier 550. As shown, the mounting plate 560 and tow hook 565 impact the barrier 550 and cause bending of the front cross member 532. This bend is facilitated in the illustrated embodiment by wedge 562. During the impact, the tow hook 565, mounting plate 560, and wedge 562 are bent as found in the illustrated embodiment of FIG. 5. As the outboard portion of the front cross member 532 bends relative to the longitudinal rail 532, the wedge 562 contacts the longitudinal rail 534 at impact point 564. Once the wedge 562 contacts the longitudinal rail 534, the wedge, driven aft by the impact with the barrier 550, drives the wedge into the longitudinal rail 534 resulting in bending of a portion of the longitudinal rail proximate the front cross member 532. The wedge 562 and the portion of the longitudinal rail 534 proximate the front cross member 532 act as a lever to help with the lateral push to move the vehicle laterally with respect to the barrier 550 and mitigate at least a portion of the impact.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A tow hook assembly comprising:
a mounting plate configured to be attached to a structural member of a vehicle at a front end of the vehicle, the mounting plate comprising a first portion and a second portion; and
a tow hook extending from the first portion of the mounting plate in a first direction away from the vehicle,
wherein the second portion of the mounting plate extends laterally outboard from the first portion in a second direction that is perpendicular to the first direction, configured such that in an impact with an object contacting the vehicle in a direction parallel to the first direction only from the tow hook assembly toward the second direction, the second portion of the mounting plate is pushed rearward causing a rotation of the tow hook assembly and, in turn, a lateral push to the vehicle in a third direction, opposite the second direction.

2. The tow hook assembly of claim 1, wherein in response to the rotation of the tow hook assembly, the tow hook extending from the first portion from the mounting plate engages the object and pushes the vehicle and the object away from one another.

3. The tow hook assembly of claim 1, wherein the structural member comprises a front cross member of the vehicle, wherein the mounting plate is attached to the front cross member at a position where the tow hook aligns with a longitudinal rail of the vehicle extending perpendicular to the front cross member.

4. The tow hook assembly of claim 3, further comprising an extension member, wherein the extension member is attached at a first end to the mounting plate configured to be received within the longitudinal rail.

5. The tow hook assembly of claim 4, wherein the extension member defines a tab proximate a second end of the extension member, opposite the first end of the extension member.

6. The tow hook assembly of claim 5, wherein the tab is configured to engage a catch attached within the longitudinal rail in response to the impact with the object contacting the vehicle.

7. The tow hook assembly of claim 6, wherein the extension member is configured to rotate toward the second direction about a location of attachment of the catch to the longitudinal rail in response to the impact.

8. The tow hook assembly of claim 7, wherein the location of attachment of the catch corresponds to a position of a second cross member attached to the longitudinal rail.

9. The tow hook assembly of claim 3, further comprising a wedge member attached to the front cross member opposite the second portion of the mounting plate and extending in a fourth direction, opposite the first direction.

10. The tow hook assembly of claim 9, wherein the wedge member is configured to impart a bend in the longitudinal rail toward the second direction in response to the impact with the object.

11. The tow hook assembly of claim 1, wherein the tow hook is positioned on the vehicle twenty five percent of a width of the vehicle from a centerline extending through a length of the vehicle.

12. A tow hook assembly comprising:
a mounting plate configured to be attached to a front cross member of a vehicle at a front end of the vehicle, the mounting plate comprising a first portion and a second portion; and
a tow hook extending from the first portion of the mounting plate in a first direction away from the vehicle, wherein the second portion of the mounting plate extends laterally outboard from the first portion in a second direction that is perpendicular to the first direction, wherein the first portion of the mounting plate is aligned on the front cross member with a longitudinal rail of the vehicle.

13. The tow hook assembly of claim 12, further comprising an extension member, wherein the extension member is attached at a first end to the mounting plate configured to be received within the longitudinal rail.

14. The tow hook assembly of claim 13, wherein the extension member further comprises a tab, wherein the tab is configured to engage a catch within the longitudinal rail in response to a small overlap frontal impact of an object with the tow hook assembly.

15. The tow hook assembly of claim 14, wherein the catch is aligned within the longitudinal rail with another cross member of the vehicle.

16. A vehicle comprising:
a vehicle structure comprising a front cross member and a longitudinal rail attached to the front cross member;
a tow hook assembly comprising:
a mounting plate configured to be attached to the front cross member of the vehicle, the mounting plate comprising a first portion and a second portion; and
a tow hook extending from the first portion of the mounting plate in a first direction away from the front cross member, wherein the second portion of the mounting plate extends laterally outboard from the first portion in a second direction that is perpendicular to the first direction, wherein the first portion of the mounting plate is aligned on the front cross member with the longitudinal rail of the vehicle.

17. The vehicle of claim 16, wherein the tow hook further comprises an extension member, wherein the extension member is attached at a first end to the mounting plate and extends into the longitudinal rail.

18. The vehicle of claim 17, wherein the extension member further comprises a tab, and the longitudinal rail further comprises a catch within the longitudinal rail, wherein the tab is configured to engage the catch within the longitudinal rail in response to a small overlap frontal impact of an object with the tow hook assembly.

19. The vehicle of claim 18, wherein the vehicle structure further comprises another cross member attached to the longitudinal rail, wherein the catch is aligned within the longitudinal rail with the another cross member.

20. The vehicle of claim 16, further comprising a wedge member attached to the front cross member opposite the second portion of the mounting plate and extending in a third direction, opposite the first direction, wherein the mounting plate is disposed outboard of the longitudinal rail relative to the vehicle.
